(19) United States
(12) Patent Application Publication
(10) Pub. No.: US 2015/0202908 A1
(43) Pub. Date: Jul. 23, 2015

(54) Combination self-sealing envelope and multi-directional display

(71) Applicant: Jordan Bundy, Seattle, WA (US)

(72) Inventor: Jordan Bundy, Seattle, WA (US)

(21) Appl. No.: 13/894,369

(22) Filed: May 14, 2013

(51) Int. Cl. B42D 15/08; B42D 15/04; A47G 1/14; A47G 1/06

(52) U.S. Cl. CPC B42D 15/08; A47G 1/0633; B42D 15/042; A47G 1/141; A47G 1/143

(57) ABSTRACT

A self-sealing envelope formed from a single sheet of stock having two printable sides, one side displaying content, and the other displaying mailer information. The apparatus can be folded one way to create the aforementioned self-sealing envelope for mailing, or folded the opposite direction to create a self-standing display of the printed media in either vertical or horizontal position.

### RELATED APPLICATION

Prior provisional patent application No. 61/646,899 was filed on May 15, 2012.

### BACKGROUND OF THE INVENTION

The present invention relates to the field of envelopes and standing displays. More specifically, the current invention relates to self-sealing envelopes. More specifically, the current invention relates to a combination mailer and content display.

Even though digital media has taken over content sharing, many people still prefer to send physical cards, letters and pictures through the mail. The main drawback of physical mail is the waste it creates when the envelope is no longer needed, and the fact that most items that fit in an envelope are flat and therefore difficult to display. The concept of this invention is to prevent waste by combining a self-sealing envelope with the intended content to be mailed, and with a multi-directional stand to simplify the exhibition of said content.

Prior patents referred to envelopes that could be transformed into self-standing displays, but required adhesives or additional steps, such as tearing and re-attaching certain parts, or never succeeded in displaying content both vertically and horizontally.

U.S. Pat. No. 7,254,912 to Zigar created a postcard that could be displayed in either direction, but required tools or perforations to create the display. U.S. Pat. No. 5,641,115 to Brewster demonstrated a combination greeting card and envelope, but did not have a secured standing position and could not be displayed horizontally. U.S. Pat. No. 5,822,897 to Ertzan produced a combination greeting card, envelope and display but required a sticker to secure the folded envelope, and required separate designs for horizontal or vertical display.

To date, there is no known patent that combines an envelope, picture, message and display that can stand vertically for content in portrait layout and horizontally for content in landscape layout without the use of additional tools or materials. There is then a need to simplify the process of mailing and displaying content such as a photo and message.

### SUMMARY OF THE INVENTION

The present invention is generally summarized as a combination self-sealing envelope, printed content, and multi-directional self-standing display. The apparatus is made from a single sheet of stock, and folding parts of the apparatus one way or the other will create its two modes, being envelope or display in either vertical or horizontal position. The invention does not require adhesives of any kind, and the two modes can be interchanged without any additional materials or tools.

There is heretofore no known combination of self-sealing envelope, content, and multi-direction display in a single unit.

### BRIEF DESCRIPTION OF THE DRAWINGS

FIG. 1 is a front view of an unfolded envelope of the present invention;

FIG. 2 is a back view of the invention of FIG. 1;

FIG. 3 is a front view of the present invention folded into envelope form;

FIG. 4 is a back view of the present invention folded into envelope form;

FIG. 5 is a perspective side view of the present invention folded into display form standing in horizontal position;

FIG. 6 is a perspective side view of the present invention folded into display form standing in vertical position;

FIG. 7 is a front view of the present invention folded into display form standing in vertical position;

FIG. 8 is a front view of the present invention folded into display form standing in horizontal position.

### DETAILED DESCRIPTION OF THE INVENTION

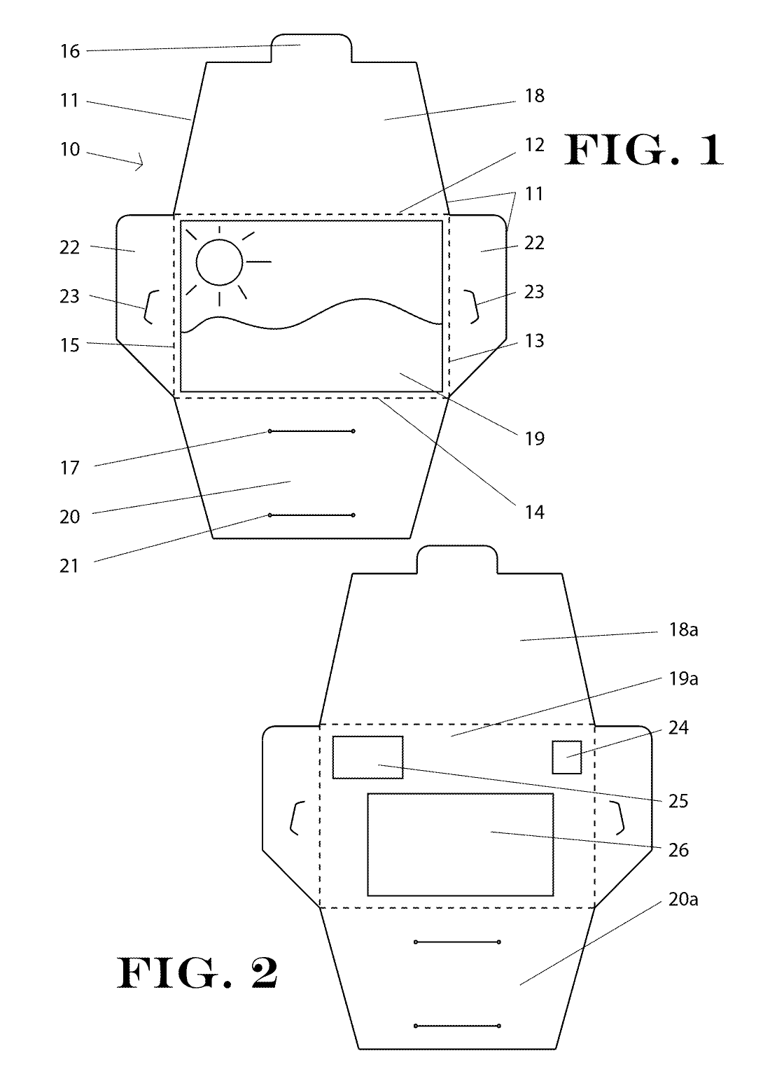

Referring now to the invention in more detail, in FIG. 1 and FIG. 2 there is shown an unfolded envelope 10 cut from a unitary sheet of material along outline 11 having fold lines 12, 13, 14 and 15, having tab 16, having flaps 18, 20 and 22, having cuts 17, 21 and 23, and content areas 19, 24, 25 and 26. Flap 18a, flap 20a and area 19a of FIG. 2 show the reverse surface of flap 18, flap 20 content area 19 from FIG. 1.

In further detail, still referring to the invention of FIG. 1, flap 18 and 20 may contain a printed message and content area 19 may display a photo. Referring now to FIG. 2, content area 19a may have mailing information printed thereon, having return address 25, recipient's address 26 and postage 24.

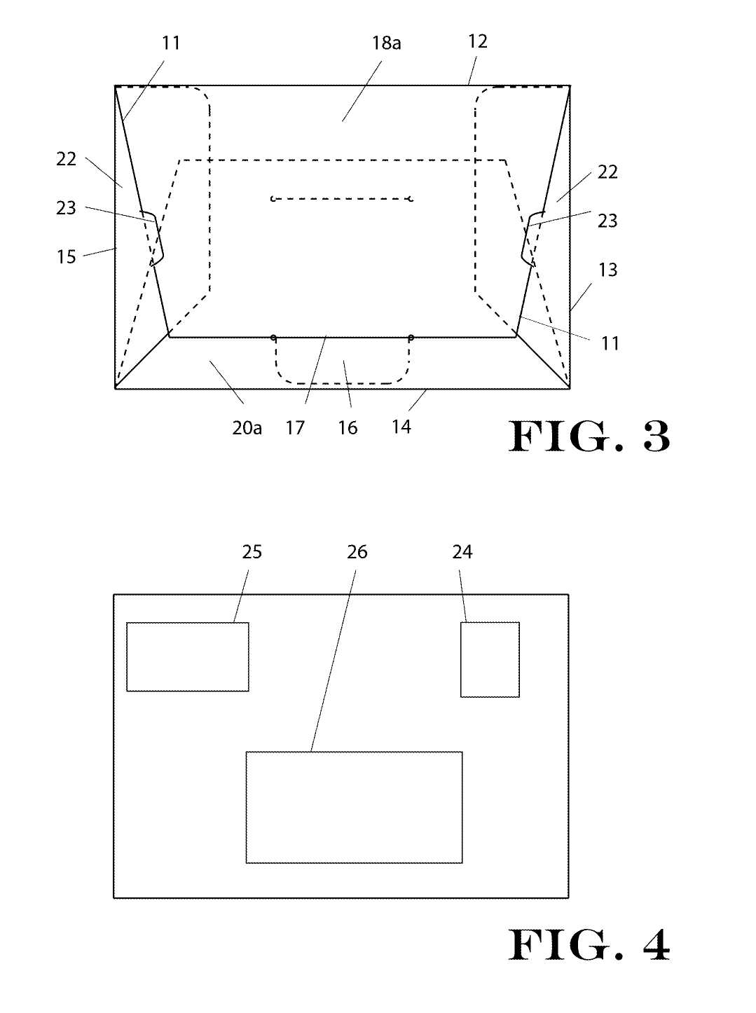

Referring now to FIG. 3, there is shown the present invention folded into envelope form where the dashed lines are hidden from view after folding. In further detail, flap 20 from FIG. 1 is folded along fold line 14, covering content area 19 from FIG. 1 and exposing flap 20a. Flaps 22 are then folded across fold lines 13 and 15 respectively, flap 18 from FIG. 1 is then folded along fold line 12, covering flap 20a and exposing flap 18a. To secure folded envelope, tab 16 is inserted into cut 17 and the edges 11 of flap 18a are inserted into cuts 23 of flaps 22.

Referring now to FIG. 4, there is shown the present invention folded into envelope form as it was in FIG. 3, viewed from the opposite angle. Postage 24, return address 25 and recipient's address 26 may be displayed for mailing purposes.

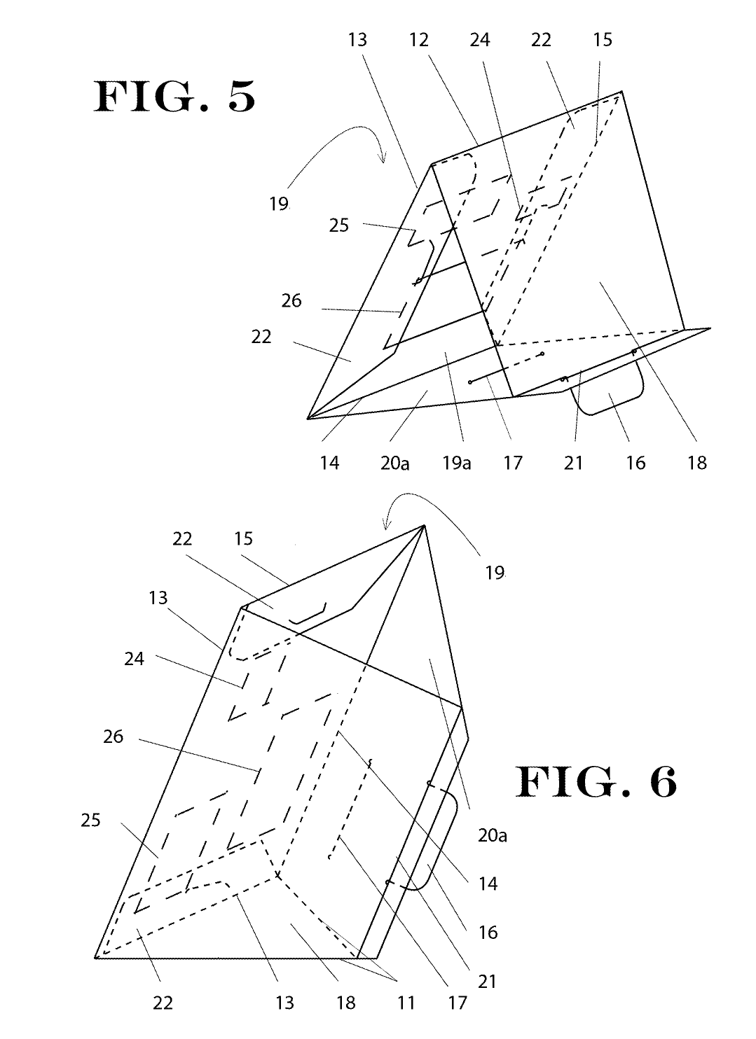

Referring now to FIG. 5, there is shown the apparatus displaying content 19 in horizontal position. In further detail, to enter standing position after apparatus is in envelope form as in FIG. 3, tab 16 is removed from cut 17, flaps 18, 20 and 22 are folded in the opposite direction along fold lines 12, 13, 14 and 15 to reveal content 19. Tab 16 is inserted into cut 21, creating a typical “A-frame.” Return address 25, recipient's address 26 and postage 24 can be seen inside the cavity of flaps 18 and 20a, printed on face 19a. The invention in display form is then placed with fold line 14 and the edge of tab 16 resting on a surface so face 19 displays photo content outward at a predetermined viewing angle.

Referring now to FIG. 6, there is shown the apparatus displaying content 19 in vertical position. Standing position is created by the same method described with FIG. 6, except the display is placed with edge 11 of flaps 18 and 20 and fold line 13 resting on a surface so content 19 is displayed outward at a predetermined viewing angle.

Still referring to FIG. 6, in order to change to the vertical position shown from the horizontal position of FIG. 5, the apparatus is simply turned ninety degrees, as noted by the movement of postage 24, return address 25 and recipient's address 26. This allows the present invention to accommodate either portrait or landscape photos without requiring additional steps to either produce said invention or to create the appropriate display.

Referring now to FIG. 7 there is shown the front view of the apparatus in vertical position displaying content 19. The dashed lines represent the form of the apparatus behind the viewing surface, with flaps 22 flush against the rear face of content area 19, tab 16 inserted into cut 21, and resting in the same manner described in FIG. 6.

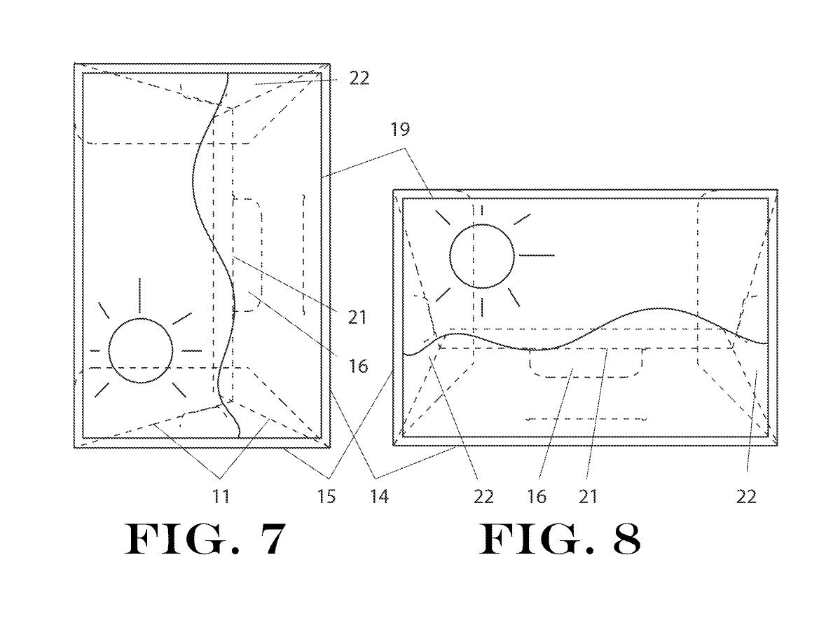

Referring now to FIG. 8 there is shown the front view of the apparatus in horizontal position displaying content 19. The dashed lines represent the form of the apparatus behind the viewing surface, with flaps 22 flush against the rear face of content area 19, tab 16 inserted into cut 21, and resting in the same manner described in FIG. 5.

The construction details of the invention shown in FIGS. 1-8 are that said envelope will be made of paper that must be sufficiently thick. Further, multiple types of paper can be used for the construction, including but not limited to photo paper, recycled paper, and paper of varying dimensions that would alter the overall dimensions of content 19, flaps 18, 20 and 22 as well as outline 11.

The advantages of the present invention include, without limitations, that it combines the content, envelope and display into one device, eliminating excess waste. The present invention allows the content to be displayed without the need of any additional frames or stands. Further, in the case that the main content is a photo, it can be displayed either horizontally or vertically and be accompanied by a second and third field of content, such as a message, that will also be displayed in standing mode. Further, content is protected from harm during mailing or transportation when folded into envelope form.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A combination self-sealing envelope and self-standing display formed from a unitary sheet of material, comprising:
a main panel having a rectangular shape, left and right side edges, top and bottom edges, and front and rear surfaces, the said front surface having content thereon;
a top flap having a foldable bottom edge attached to said top edge of main panel, two acute angled side edges, a top edge shorter than and parallel to said bottom edge with a contiguous tab, front and rear surfaces, and being sized to be capable of overlaying said main panel substantially;
a bottom flap having a foldable top edge attached to said bottom edge of main panel, two acute angled side edges, a bottom edge shorter than and parallel to said top edge, having two separate but parallel cuts for receiving said tab of top flap, and being sized to be capable of overlaying said main panel substantially;
a side flap having a foldable side edge attached to said left side of main panel, and being sized to overlap the entirety of said angled side of bottom flap;
a side flap having a foldable side edge attached to said right side of main panel, and being sized to overlap the entirety of said angled side of bottom flap;
whereby said combination self-sealing envelope and self-standing display is foldable into an envelope state by folding said flaps in a predetermined manner and inserting said tab into first of said two cuts, thereby sealing said envelope;
whereby said combination self-sealing envelope and self-standing display exhibits said front surface of main panel in either horizontal or vertical fashion by folding said flaps in a predetermined manner and inserting said tab into second of said cuts, thereby securing display.

2. The combination self-sealing envelope and self-standing display of claim 1 wherein said main content is a printed photo.

3. The combination self-sealing envelope and self-standing display of claim 1 wherein said front surface of top flap has a message thereon.

4. The combination self-sealing envelope and self-standing display of claim 1 wherein said rear side of main panel has return address, recipient address and postage thereon.

5. The combination self-sealing envelope and self-standing display of claim 1 wherein said side flaps have a half-moon shaped cutout whereby said angled edge of top flap can be held securely when sealing said envelope.
